(19) United States
(12) Patent Application Publication
(10) Pub. No.: US 2026/0019969 A1
(43) Pub. Date: Jan. 15, 2026

(54) REPEATER ASSISTED MOBILITY

(71) Applicant: Nokia Solutions and Networks Oy, Espoo (FI)

(72) Inventors: Roy YANG, Buffalo Grove, IL (US); Axel MUELLER, Paris (FR); Kevin WANUGA, Souderton, PA (US)

(73) Assignee: Nokia Solutions and Networks Oy, Espoo (FI)

(21) Appl. No.: 18/881,901

(22) PCT Filed: Jul. 12, 2022
(86) PCT No.: PCT/EP2022/069387

§ 371 Date: Jan. 7, 2025

(51) Int. Cl. H04W 56/00; H04W 24/10; H04W 36/00; H04W 74/0833

(52) U.S. Cl. CPC H04W 56/004; H04W 24/10; H04W 36/0058; H04W 74/0833

(57) ABSTRACT

A repeater relays communications between UEs and a first BS. The repeater measures a time difference between signals received from the first BS and from a second BS. The repeater performs cell measurements of these signals. The repeater sends, to the first BS, information indicative of the measured time difference and of the cell measurements. The first BS communicates with the UEs through the repeater. The first BS receives, from the repeater, information indicative of a time difference between signals received from the first BS and signals received from a second BS as measured by the repeater, and of cell measurements by the repeater of these signals. The first BS makes a handover decision for the UEs based at least on the received information indicative of the cell measurements.

### TECHNICAL FIELD

Exemplary embodiments herein relate generally to wireless communication systems and, more specifically, relate to repeaters used in such systems.

### BACKGROUND

Cellular repeaters are widely used in the 2G (second generation)/3G (third generation)/4G (fourth generation) wireless networks to provide coverage extension. A classical RF (radio frequency) repeater receives the signal from the nearby base station, amplifies and retransmits the signal to the nearby user equipment in the downlink direction. In the uplink direction, the RF repeater receives signals from the UE (user equipment, a wireless device), amplifies the signals and retransmits the signals to the base station.

The 5G NR (fifth generation, new radio) repeaters support beamforming capabilities, i.e., they use a narrow beam on the access link to communicate with the UE and use a narrow beam on the backhaul link to communicate with the base station. In 3GPP, 5G repeaters used to be referred to as “Smart” Repeaters (SRs) and are now known as “Network-controlled” Repeaters (NCRs), which implies that some intelligence is required to dynamically manage the directivities of the beams generated by the repeater according to the traffic conditions. However, the decisions are taken by the Network (NW) and the repeater is controlled via a dedicated control link.

While the 5G NR repeater is still being standardized, there are issues that can be improved in the use of these and similar repeaters.

### BRIEF SUMMARY

This section is intended to include examples and is not intended to be limiting.

In an exemplary embodiment, a repeater comprises means for performing: relaying communications between a plurality of user equipment and a first base station; measuring a time difference between signals received from the first base station and signals received from a second base station; performing cell measurements of signals received from the first base station and of signals received from the second base station; and sending, to the first base station, information indicative of the measured time difference and of the cell measurements.

In another exemplary embodiment, a method comprises relaying, by a repeater, communications between a plurality of user equipment and a first base station, and measuring, by the repeater, a time difference between signals received from the first base station and signals received from a second base station. The method also comprises performing, by the repeater, cell measurements of signals received from the first base station and of signals received from the second base station, and sending, by the repeater to the first base station, information indicative of the measured time difference and of the cell measurements.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

In a further exemplary embodiment, an exemplary repeater includes one or more processors and one or more memories including computer program code. The one or more memories and the computer program code are configured to, with the one or more processors, cause the repeater to: relay communications between a plurality of user equipment and a first base station; measure a time difference between signals received from the first base station and signals received from a second base station; perform cell measurements of signals received from the first base station and of signals received from the second base station; and send, to the first base station, information indicative of the measured time difference and of the cell measurements.

An exemplary computer program product includes a computer-readable storage medium bearing computer program code embodied therein for use with a computer. The computer program code includes: code for relaying communications between a plurality of user equipment and a first base station; code for measuring a time difference between signals received from the first base station and signals received from a second base station; code for performing cell measurements of signals received from the first base station and of signals received from the second base station; and code for sending, to the first base station, information indicative of the measured time difference and of the cell measurements.

In a further exemplary embodiment, a first base station comprises means for performing: communicating with a plurality of user equipment though a repeater, receiving, from the repeater, information indicative of a time difference between signals received from the first base station and signals received from a second base station as measured by the repeater, and of cell measurements by the repeater of signals received from the first base station and of signals received from the second base station; and making a handover decision for the plurality of user equipment based at least on the received information indicative of the cell measurements.

In an exemplary embodiment, a method is disclosed that includes communicating with a plurality of user equipment though a repeater. The method includes receiving, from the repeater, information indicative of a time difference between signals received from the first base station and signals received from a second base station as measured by the repeater, and of cell measurements by the repeater of signals received from the first base station and of signals received from the second base station. The method includes making a handover decision for the plurality of user equipment based at least on the received information indicative of the cell measurements.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary first base station includes one or more processors and one or more memories including computer program code. The one or more memories and the computer program code are configured to, with the one or more processors, cause the first base station at least to: communicate with a plurality of user equipment though a repeater, receive, from the repeater, information indicative of a time difference between signals received from the first base station and signals received from a second base station as measured by the repeater, and of cell measurements by the repeater of signals received from the first base station and of signals received from the second base station; and make a handover decision for the plurality of user equipment based at least on the received information indicative of the cell measurements.

An exemplary computer program product includes a computer-readable storage medium bearing computer program code embodied therein for use with a computer. The computer program code includes: code for communicating with a plurality of user equipment though a repeater, code for receiving, from the repeater, information indicative of a time difference between signals received from the first base station and signals received from a second base station as measured by the repeater, and of cell measurements by the repeater of signals received from the first base station and of signals received from the second base station; and code for making a handover decision for the plurality of user equipment based at least on the received information indicative of the cell measurements.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 1A is a block diagram of circuitry illustrated in a network node that is suitable for implementing any of the network nodes in FIG. 1;

FIG. 1B is a block diagram of circuitry illustrated in a network node for a repeater 130, illustrating loopback techniques;

FIG. 2 illustrates a DAPS handover;

FIGS. 3A and 3B illustrate L1 inter-cell change for signaling for baseline handover (FIG. 3A) and L1 inter-cell mobility (FIG. 3B);

FIG. 4 is a block diagram illustrating how a repeater (e.g., an NCR) multiplexes broadcast transmissions (i.e., SSBs) from two different donors;

FIG. 5 is a diagram illustrating cell mobility when a UE is served by a repeater;

FIG. 6 is a diagram illustrating network-controlled repeater assisted mobility, in accordance with an exemplary embodiment;

FIG. 7 is a diagram illustrating delta-T and uplink propagation in an exemplary embodiment;

FIG. 8 illustrates DL and UL Timing for a single repeater, two donor topology, in an exemplary embodiment;

FIG. 9 is a message flowchart for repeater-assisted mobility when Msg1 is bypassed;

FIG. 10 is a message flowchart for repeater-assisted mobility when Msg2 content is sent by the source gNB.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The exemplary embodiments herein describe techniques for repeater assisted mobility. Additional description of these techniques is presented after a system into which the exemplary embodiments may be used is described.

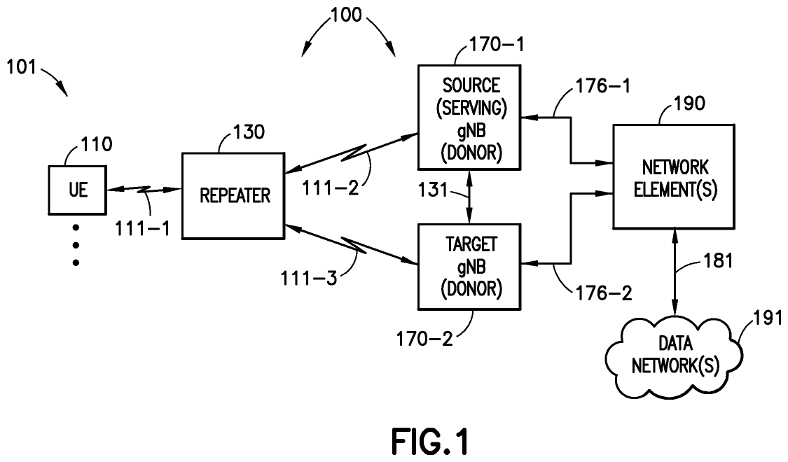

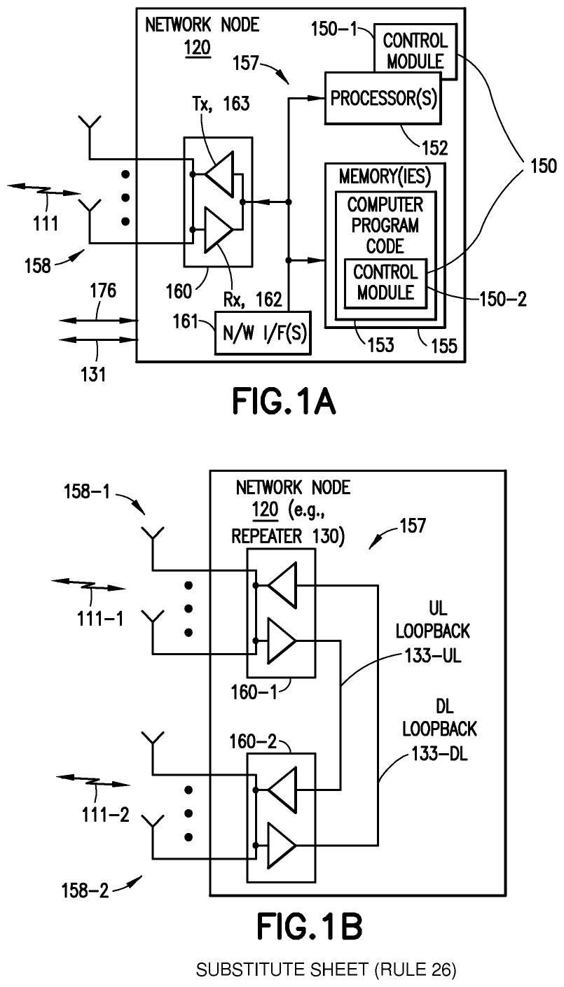

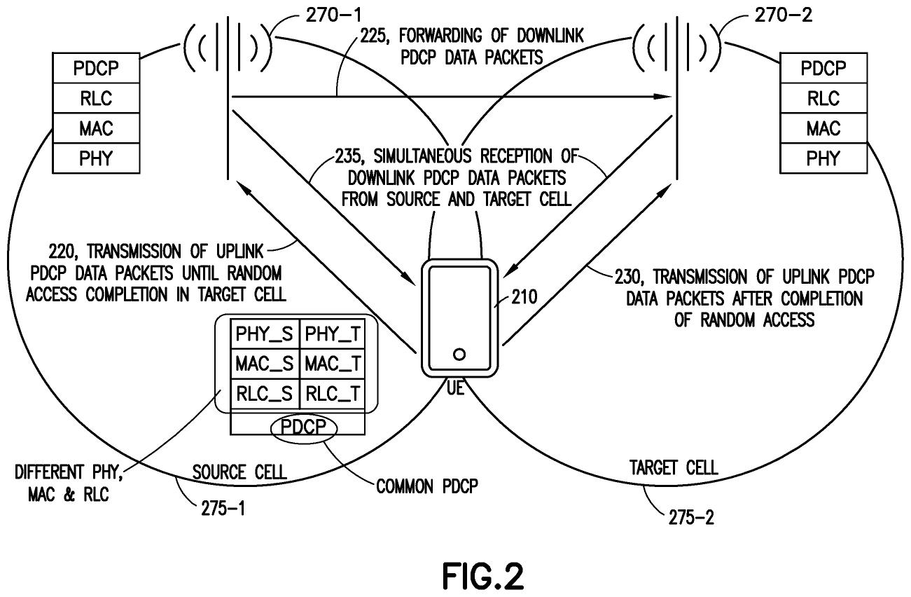

Turning to FIG. 1, this figure shows a block diagram of one possible and non-limiting exemplary system 101 in which the exemplary embodiments may be practiced. A user equipment (UE) 110, a repeater 130, a source gNB 170-1, a target gNB 170-2, network element(s) 190, and data network(s) 191 are illustrated as network nodes in this system. Although only one UE 110 is shown, there would be multiple UEs 110. In FIG. 1, a user equipment (UE) 110 is in wireless communication with a wireless network 100, which includes the repeater 130, the source gNB 170-1, a target gNB 170-2, and network element(s) 190. The source and target gNBs may be referred to as donors, as described below. Furthermore, the source gNB 170-1 may also be referred to as a “serving” gNB, and these may also be characterized as serving cell and neighbor cell instead of source/serving gNB and target gNB, respectively. It is known that a cell is formed and operated by a base station (BS) such as a gNB. Regardless of the terminology being used, a UE or multiple UE(s) are initially connected to a first network node (e.g., gNB 170-1) (or a cell of the same) in order to connect to network 100, and the UE or multiple UEs will be handed over to a second network node (e.g., gNB 170-2) (or a cell of the same) in order to continue a connection with network 100.

Concerning network 100, the repeater 130 should be considered as a network node of the access network 100 as an analog repeater is in a wired network, although the wireless repeater's operation is transparent to the UEs. And the UEs connect to the base stations (BSs) via the repeaters in the legacy way. The repeater proxies/emulates, in the RF domain, the UE in the UL, and the base station in the DL. The repeater 130, in an exemplary embodiment, uses the RF domain, covering pure analog signal repetition (before an ADC) or digital signal (e.g., repeat after the ADC to get digital signal and send to a DAC to convert back to analog signal). Both cases may be considered as “amplify-forward”. The repeater 130 is able to connect through wireless link 111-2 to the source gNB 170-1, and through wireless link 111-3 to target gNB 170-2. In general, each of the links 111-2 and 111-3 is actually two separate links. There is the amplify-and-forward portion of the link that is acting as a proxy for the base station in DL and the UE in UL, and there is also a control link through which the network is controlling and configuring the NCR 130 during the amplify-and-forward operation. On these control links, the NCR 130 can be thought of as acting like a specially designated UE, although still being a network node.

A UE is a wireless, typically mobile device that can access wireless network 100 via wireless link 111-1. The source gNB 170-1 connects via link(s) 176-1 to network element(s) 190, and the target gNB 170-2 connects via link(s) 176-2 to the network element(s) 190. Two or more gNBs 170 communicate via link(s) 131. The link(s) 131 and 176 may be wired, such as optical cable, or wireless. The network element(s) 190 may include many different network elements, as described below, and may connect via link(s) 181 to one or more data network(s) 191 such as the Internet.

Each gNB 170 is a base station that provides access by wireless devices such as the UE(s) 110 (e.g., and repeater 130 acting as a UE or UEs in UL) to the wireless network 100. The gNB 170 may be, for instance, a base station for 5G, also called New Radio (NR), and may also be referred to as a RAN node. In 5G, the RAN node may be a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN may include multiple gNBs, which may also include a central unit (CU) (gNB-CU) and distributed unit(s) (DUs) (gNB-DUs) (neither of which is shown). Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The gNB-DU is a logical node hosting RLC, MAC and PHY layers of the gNB or en-gNB, and its operation is partly controlled by gNB-CU. One gNB-DU supports one or multiple cells. One cell is supported by one gNB-DU. The gNB-DU terminates the F1 interface connected with the gNB-CU. The gNB 170 may also be an eNB (evolved NodeB) base station, for LTE (long term evolution), or any other suitable base station.

The wireless network 100 may include a network element or elements 190 that may include core network functionality, and which provides connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity) functionality and/or SGW (Serving Gateway) functionality. These are merely exemplary functions that may be supported by the network element(s) 190, and note that both 5G and LTE functions might be supported.

Any of the nodes 110, 130, 170-1, 170-2 and 190 may be implemented by circuitry illustrated in the node 120 of FIG. 1A. Turning to FIG. 1A, the node 120 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the node 120 to perform one or more of the operations as described herein. Note that the functionality of the control module 150 may be distributed, such as being distributed between a DU and a CU.

The node 120 includes one or more transceivers 160 comprising a receiver (Rx) 162 and a transmitter (Tx) 163, coupled to one or more antennas 158 and communicating via a wireless link 111.

The one or more network interfaces 161 communicate over a network such as via the link(s) 131 and/or 176. Two or more gNBs 170 communicate using, e.g., link(s) 131. For gNBs, the link(s) 131 may be wired or wireless or both and may implement, e.g., an Xn interface for 5G, an X2 interface for LTE, or other suitable interface for other standards. Other interfaces can be used, depending on which node 110, 130, 170, or 190 is being described. The one or more buses 157 may be address, data, or control buses, and may include any interconnection mechanism, such as a series of lines on a motherboard or integrated circuit, fiber optics or other optical communication equipment, wireless channels, and the like.

Note that a repeater 130 may implement loopback techniques. FIG. 1B is a block diagram of circuitry illustrated in a network node for a repeater 130, illustrating loopback techniques. This example shows two transceivers 160-1 and 160-2, and two sets of antennas 158-1 and 158-2, and the rest of the circuitry is removed for ease of description. For UL, the repeater 130 (as network node 120) can receive data from the UE 100 via link 111-1 via a receiver of the transceiver 160-1, and use an UL loopback path 133-UL to a transmitter of the transceiver 160-2 and transmitted via link 111-2 to the gNB 170-1 (in this example, could also be 170-2). Similarly, for DL, the repeater 130 (as network node 120) can receive data from the gNB 170-1 via link 111-2 and via a receiver of the transceiver 160-2, and use a DL loopback path 133-DL to a transmitter of the transceiver 160-1 and transmitted via link 111-1 to the UE 110. While there are two sets of antennas 158-1 and 158-2 shown, this is for ease of description, and there could be only one set of antennas 158. The UL path 133-UL and DL path 133-DL may be communicated entirely using the bus 157 or be an addendum to the bus 157.

It is noted that the loopback may also be considered to be a relay operation. That is, the repeater 130 can be considered to relay messages between the UE and gNB nodes, and loopback is one way to represent that relaying. In any signaling diagrams herein, the repeater 130 is assumed to be relaying messages via the appropriate loopback path 133.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 and memories 155, and also such virtualized entities create technical effects.

The computer readable memories 155 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 155 may be means for performing storage functions. The processors 152 may be of any type suitable to the local technical environment, and may include one or more of general-purpose computers, special purpose computers, microprocessors, digital signal processors (DSPs) and processors based on a multi-core processor architecture, as non-limiting examples. The processors 152 may be means for performing functions, such as controlling the UE 110, repeater 130, gNB 170, and network element(s) 190, and other functions as described herein.

In general, the various embodiments of the user equipment 110 can include, but are not limited to, cellular telephones (such as smart phones, mobile phones, cellular phones, voice over Internet Protocol (IP) (VOIP) phones, and/or wireless local loop phones), tablets, portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 110 could be any end device that may be capable of wireless communication. By way of example rather than limitation, the UE may also be referred to as a communication device, terminal device (MT), a Subscriber Station (SS), a Portable Subscriber Station, a Mobile Station (MS), or an Access Terminal (AT).

Having thus introduced one suitable but non-limiting technical context for the practice of the exemplary embodiments, the exemplary embodiments will now be described with greater specificity.

As stated previously, the 5G NR repeater is being standardized. While the standardization is not yet complete, the inventors have determined that there are advantages and disadvantages of a NR repeater, as compared with an IAB device. For instance, for coverage improvement/extension for an area without optical fiber access, both IAB and repeater nodes can be used, with each having their own advantages and disadvantages. Consider the following.

1) A NR IAB is highly spectrally efficient but introduces additional delay, as IAB is a “regenerative relay”, which has both Mobile Terminal (MT) and Distributed Unit (DU) functions built in.

2) RF repeaters are non-regenerative (amplify-forward) and thus introduce minimal latency, but they reduce spectral efficiency in the whole cell by actively amplifying signal and noise. They are also a non-negligible source of “longer than expected distance” interference (echo). NR RF repeaters can use narrow beams to address some of these interference issues. Additionally, RF repeaters tend to amplify noise even if no traffic is present (NR NCRs can also address this issue).

3) A repeater has significant cost advantage over an IAB device. A repeater has less energy consumption, smaller form factor and less weight for easier deployment.

Some 3GPP participants are heavily promoting Network Controlled Repeaters (NCRs) due to cost advantage over IAB devices. In addition, the area of mixed deployment of IAB nodes and the repeater nodes is being seen, where either a gNB node or an IAB node can be the parent of a repeater. Many top tier cellular service providers are deploying/performing trials with 5G repeaters in their networks.

Another concern is repeaters that support more than one donor. A donor is a base station to which the repeater can connect (e.g., source gNB 170-1 and target gNB 170-2 in FIG. 1). In this context, the NCR is non-regenerative. That is, it relies on using dedicated physical resource (e.g., SSB beams) from the donor to provide service to the UEs in its access link. Dedicating a number of SSB beams to the repeater reduces the number of SSB beams available for use by the donor (i.e., reduces the spatial resolution of the SSB beams for the donor coverage area).

With a repeater that is capable of supporting more than one donor, the repeater can “pool” SSBs from several donors together to support the spatial directivity needs in its access link. As a result, each donor may dedicate fewer SSBs for the repeater thus can keep more SSB beams for its own use.

A repeater that supports multiple donors can improve robustness to the operation. In particular, in case one donor fails, the UEs served by the repeater can fall back to the working donor.

Repeaters can be mounted on a train or a car to provide better service for the UEs inside the moving vehicle. This is because of the following:

1) The repeater amplifies both downlink and uplink signal to and from the UE, hence better SNR and higher throughput can be achieved by the UE.

2) The repeater is less constrained by size or power consumption compared with a UE, hence a higher gain in power or better beam steering (more panels, more antenna elements) can be achieved by a repeater.

Another possible concern includes the following. There has been a feasibility discussion regarding repeaters in 3GPP. Specifically, a 5G wireless repeater (e.g., NCR) is expected to have the capability to achieve time and frequency synchronization over the air with the donor. Additionally, the repeater is expected to be able to search for and detect the SSB signals using its backhaul beam during the SSB burst period from the donor gNB. The repeater is also expected to determine the strongest SSB signal out of the SSB signals that the repeater has detected. (i.e., the repeater needs to measure and compare the RSRP/RSRQ of SSB signals it detects).

The repeater is expected to identify the beam id of the strongest SSB signal in order to determine the radio frame boundary of the donor (i.e., the repeater needs to perform some simple demodulation to the SSB signal and derive the Cell ID and the beam index in the process to determine which beam the repeater has detected and what is the correct offset in samples of this SSB beam from a radio frame perspective).

The repeater is expected to track the strongest SSB signal and to maintain a steady time reference to the donor, wherein the repeater performs SSB detection periodically in order to be time- and frequency-synchronized to the donor. With a repeater in motion, the repeater should be able to search and detect the SSBs from the target donor and compare the RSRP/RSRQ differences between the source donor and the target donor. In the meantime, the repeater should be able to detect the time difference between the current backhaul path to the source donor and the future backhaul path to the target donor by measuring the time difference of arrival (TDOA) of the SSBs from the source donor and the target donor, using the source donor as a time reference.

One issue that arises for both UEs and repeaters concerns handover, when a UE is transferred from a source gNB to a target gNB. One such handover is Dual Active Protocol Stack (DAPS) handover.

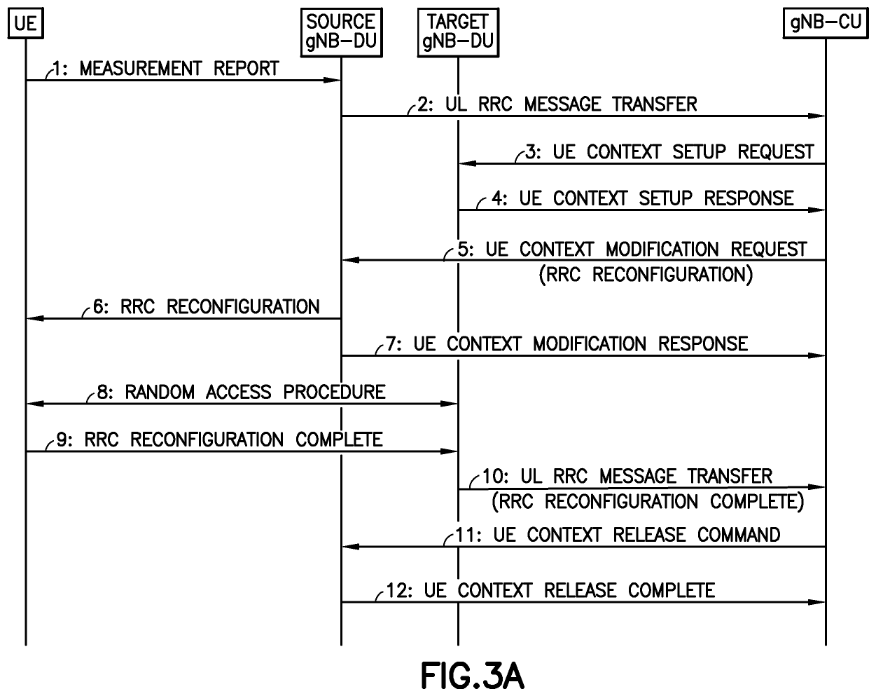

One main idea for DAPS is illustrated in FIG. 2, which illustrates a DAPS handover. DAPS is a release 16 feature to improve the reliability and latency for UE handover. The main idea is that after a source gNB 270-1 (shown forming a source cell 275-1) triggers the handover, the data traffic from the source gNB is still on going towards the UE 210, together with the data traffic from the target gNB 270-2 (shown forming a target cell 275-2) towards the same UE 210, until the RACH procedure from source to the target gNB is reliably complete, and the UE's uplink switches to the target gNB. Both the source and target gNBs have PDCP, RLC,

MAC, and PHY layers. The UE has separate source PDCP_S, RLC_S, MAC_S and target PDCP_T, RLC_T, MAC_T layers, but a common PDCP layer. Reference 220 indicates there is a transmission of uplink PDCP data packets until there is a random-access completion in the target cell. Reference 225 indicates there is forwarding of downlink PDCP data packets. Reference 230 indicates there is transmission of uplink PDCP data packets after completion of random access, and reference 235 indicates there is simultaneous reception of downlink PDCP data packets from source to target cell.

The benefits of DAPS are: 1) reduction of the data interruption and 2) improvement in HO robustness. There are, however, issues with DAPS, including the following. DAPS requires simultaneous reception from two gNBs (different PCI, different timing), which requires a special category of UE that has two independent receivers. DAPS still requires the UE to perform the full PRACH procedure with the target gNB. No group handover is possible in DAPS.

The repeater backhaul beam may be time domain duplexed, i.e., it cannot support simultaneous reception from both source and target donors to support DAPS. It is also quite difficult for the repeater to generate two spatially separated access beams towards the UE in the access link. Further, the spatial diversity leveraged by DAPS may not exist in a repeater access scenario.

By contrast, the exemplary embodiments herein do not require dual reception and are applicable to non-DAPS capable UEs and the DAPS capable UEs in a fall back (single receiver) mode. These exemplary embodiments aim to reduce data interruption and messaging overhead from the conventional handover framework. These exemplary embodiments may skip the MSG1 (which is instead resolved by the repeater) and may use a preconfigured time for RAR (MSG2), and thus remove the need for RAR window. Thereby, the exemplary embodiments herein use a different RACH procedure.

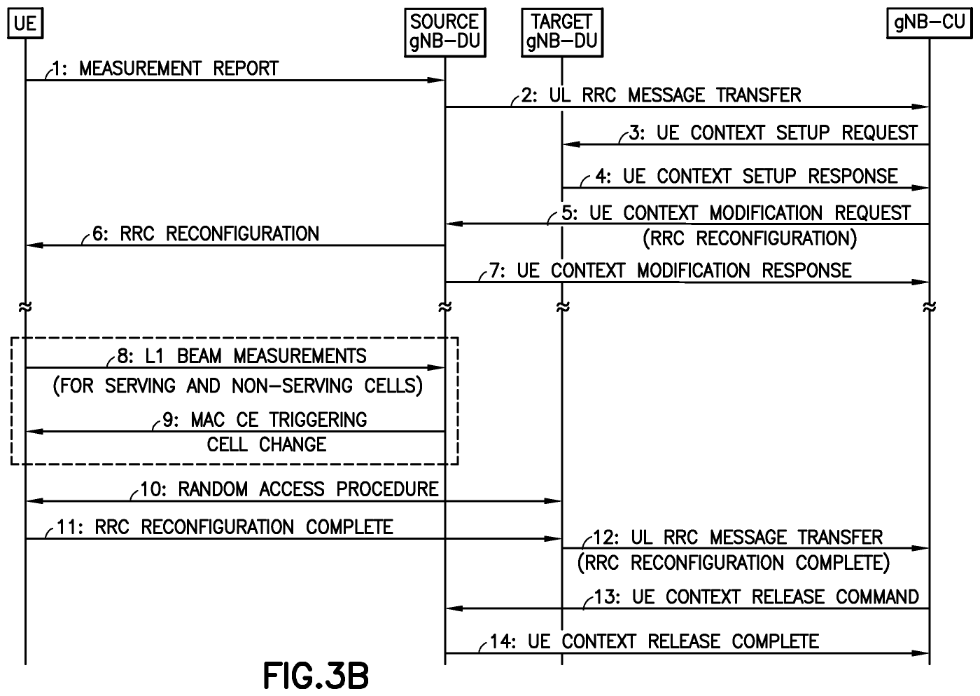

There are also L1/L2 inter-cell mobility discussions in RAN1/RAN4, where “L” is a layer. Main ideas are illustrated by FIGS. 3A and 3B, which illustrate L1 inter-cell change for signaling for baseline handover (FIG. 3A) and for L1 inter-cell mobility (FIG. 3B). That is, the diagram in FIG. 3A is the L3 based legacy handover (step 6 triggers HO). The diagram in FIG. 3A is the L1-L2 based handover (step 9 triggers HO). Full legacy RACH is required in both cases.

As shown in FIG. 3B, there are proposals to perform handover through L2 messaging (i.e., MAC CE) (see FIG. 3B and the box marked as reference 381). Comparing with the conventional L3 based handover (flowchart in FIG. 3A), this kind of handover would be faster and with shorter data interruption.

The proposals still require the full random-access procedure (step 10), the measurement report comes from the UE (step 1), and the proposals are per-UE based. By contrast, a full random-access procedure need not be used herein, the measurement report may come from the repeater herein, and group handovers are proposed in certain exemplary embodiments herein.

The concept of L1/L2 based handover is still compatible with the examples herein, e.g., MAC CE can be used herein to trigger the cell switch in order to further reduce the data interruption during handover.

Full legacy RACH is required in L1/L2 inter-cell mobility, as in FIGS. 3A and 3B.

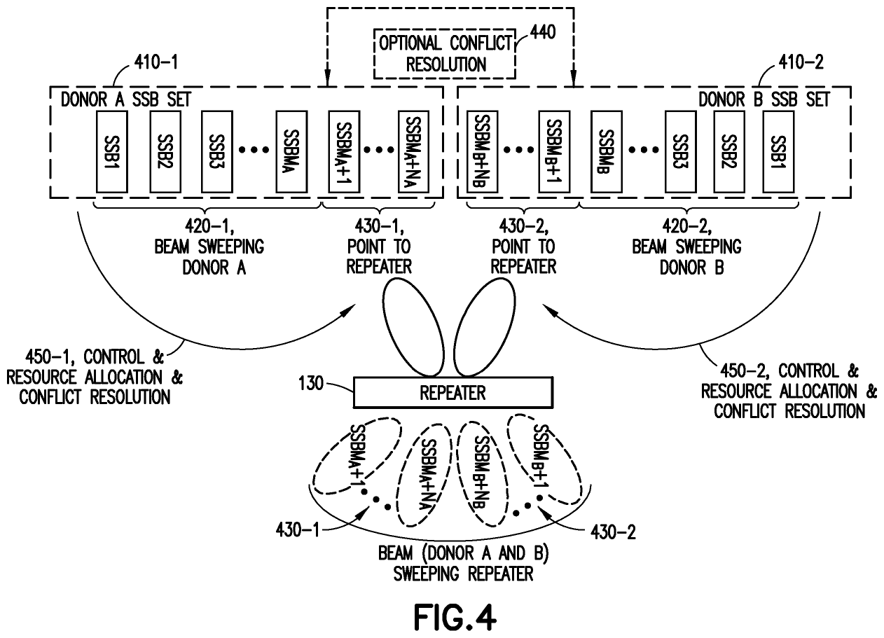

A scheme has previously been proposed for a repeater to support multi-donor in U.S. patent application Ser. No. 17/502,955, filed on Oct. 15, 2021. FIG. 4 shows one example of a main exemplary block diagram of such a system. The exemplary embodiments, disclosed in the following, aim to address the mobility procedure systems such as the one as shown in FIG. 4, which is a block diagram illustrating how a repeater (e.g., an NCR) multiplexes broadcast transmissions (i.e., SSBs) from two different donors

There is a Donor A SSB set of beams 410-1 (e.g., formed by gNB 170-1) and a Donor B SSB set of beams 410-2 (e.g., formed by gNB 170-2). There are MA beam sweeping beams 420-1 for donor A and MB sweeping beams 420-2 for donor B. These are direct access beams for UEs not connected through the repeater 130. There are NA beams 430-1 that point toward the repeater from donor A and NB beams 430-2 that point toward the repeater from donor B. The repeater 130 consequently multiplexes a first set of NA beams 430-1 and a second set of NB beams 430-2. The repeater 130 performs beam sweeping for donors A and B. There is an optional conflict resolution channel 440 between the donors and control and resource allocation and conflict resolution channels 450-1 (donor A to repeater) and 450-2 (donor B to repeater).

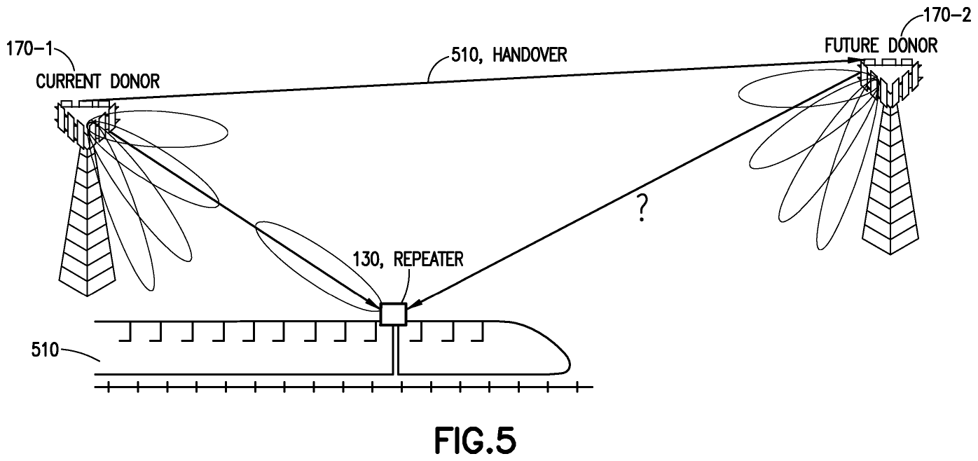

One issue with this or any system where the repeater is moving relative to the base stations is illustrated in FIG. 5, which is a diagram illustrating cell mobility when a UE is served by a repeater. A train 510 has a repeater 130 on it, and the train is moving away from the current donor gNB 170-1 and towards a future donor gNB 170-2. There is handover signaling 510 (e.g., via link(s) 131) between the two gNBs 170. As the repeater travels towards the target donor, clearly all UEs served by the repeater access link will need to hand over from the current, source donor to the future, target donor, and the question mark indicates the beams for this have not been decided.

Comparing with normal UE handover between two gNBs (i.e., without the repeater 130), there are some unique characteristics about the handover of the UEs served by a moving repeater. More specifically, consider the following.

1) The UE's relative position to the repeater may remain largely unchanged, i.e., the access beam direction and pathloss in the access link remain the same before and after the handover.

2) The repeater's relative position to the source and the target donor keeps changing, i.e., the backhaul beam direction (needed to switch from source to target) and pathloss have significantly changed. In other words, the condition that triggers the handover (e.g., RSRP/RSRQ difference between the source and the target donor) is almost entirely dependent on the backhaul link.

3) The changes in timing and pathloss over the backhaul link for a moving repeater are common for all the UEs served by the access link.

For the UEs that are in the active state with the source donor, it is desirable to reduce the interruption in data transmission as much as possible in the process of handing over from the source to the target donor. From the network level, it is desirable to avoid a large group of UEs engaging in RACH at the same time, as this requires a large number of “expensive” RACH resources to be allocated to make this feasible. (PRACH preamble sequences in general—especially the contention free ones—are a very limited resource in 5G NR).

There is an opportunity in this scenario for the repeater to assist in the handover process for a plurality of UEs served by the repeater to improve the user experience and network efficiency.

The present exemplary embodiments address this opportunity and some or all of issues presented above (along with potentially other issues) at least by providing a method and a system for the network-controlled repeater to assist in the handover of one or more UEs in its access link, wherein the repeater measures the power and time differences between the source cell and the target cell in the backhaul link and sends the measurement report to the source gNB. The power difference may be used by the source gNB to make a handover decision. The time difference of arrival (TDOA; though not equal to the TDOA framework from NR positioning) of the SSB beams may be used by the target gNB or the source gNB to derive the uplink timing advance relative to the target gNB for the UEs, thereby removing the need for Msg1. The source gNB may initiate a group HO by collecting the identities of the plurality of UEs served by the repeater. By way of the source gNB, the target gNB may provide the UEs with information such as target gNB configuration and the future UE identity (used by the target) in advance. There are two potential techniques for the (optional) RAR handling, as follows.

1) The scheduling of RAR transmission in the target cell (i.e., Msg2 DL assignment such as slot, physical resource, and the like) could be configured by the target gNB and conveyed to the UE via source gNB before handover. One view of this is that relevant information is sent with legacy RAR content (such as a PDU). Thereby, the UE can promptly receive Msg2 after achieving synchronization with the target gNB without Msg1/RACH preamble transmission in the target cell. It is also noted the target gNB can alternatively convey the RAR transmission directly to the UE, bypassing the source gNB.

2) The scheduling of Msg3 transmission in the target cell (i.e., Msg3 UL grant such as slot, physical resource, and the like) could be configured by the target gNB and conveyed to the UE via source gNB before handover. One view of this is dedicated signaling (e.g., a PDU) could be used to configure each UE. Thereby the UE can promptly transmit Msg3 after achieving synchronization with the target gNB without Msg1/RACH preamble transmission and Msg2/RAR reception in the target cell.

In addition, the exemplary embodiments herein also provide the recommended signaling between the repeater, the UE, the source and target gNB to allow such system to be used in 5G NR networks.

Furthermore, many UEs in a moving train may need to perform cell handover (HO) at the same time. This causes a bottleneck in network performance due to large amounts of Msg1 and Msg2 handling, the configured inter-cell measurement objects (MOs) and the associated measurement gaps (MGs), which lead to reduced UE throughput.

Mobile network-controlled repeaters (NCRs) are already considered to serve UEs in high-speed trains and similar circumstances.

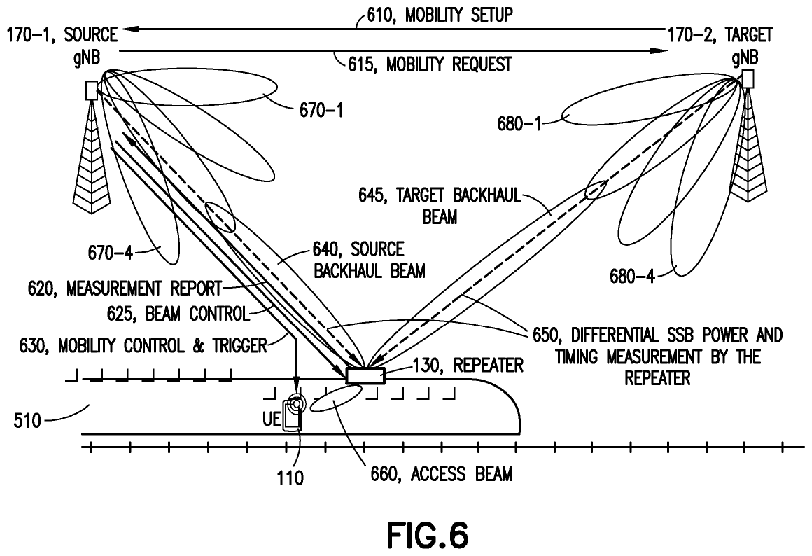

An exemplary network with the network-controlled repeater node, the UE, the source and target gNB nodes is depicted in FIG. 6. The UE 110 has an access beam 660 to the repeater 130, which communicates via source backhaul beam 640 with the source gNB 170-1 and via target backhaul beam 645 with the target gNB 170-2.

The source backhaul beam 640 is used for at least the indicated signaling: a measurement report 620 sent from the repeater 130 to the source gNB 170-1; beam control signaling 625 from the source gNB 170-1 to the repeater 130; and mobility control and trigger signaling from the source gNB 170-1 to the UE 110 (and through the repeater 130). Both the source backhaul beam 640 and target backhaul beam 645 include (see reference 650) differential SSB power and time measurement(s) by the repeater 130. Between the source gNB 170-1 and target gNB 170-2, there is mobility setup signaling 610 and mobility request signaling 615.

In further detail, the Network-Controlled Repeater (NCR) 130 is mounted on the train 510, which is travelling from the source gNB 170-1 towards the target gNB 170-2. Both source gNB and target gNB have a number of SSB beams 670-1 to 670-4 and 680-1 to 680-4, respectively, pointing to difference spatial directions, and these beams are active during the SSB beam sweeping period. It is noted that while an equal number of beams is shown on both gNBs, this does not have to be the case, and each gNB 170 can have a different number of beams. The repeater 130 has initially established the connection with the source gNB by pointing the backhaul beam towards the strongest SSB beam of the source gNB (shown as source backhaul beam 640). The UE 110, which is inside the train 510, initially communicates with the source gNB 170-1 through the repeater's access beam 660 and the source's backhaul beam 640.

As the train 510 travels away from the source gNB 170-1 towards the target gNB 170-2, the SSB signal of the target gNB 170-2 may become stronger than the SSB signal of the source gNB. The UE will need to handover from the source gNB to the target gNB. One uniqueness about this scenario is that the UE's relative position to the repeater (i.e., the access link) may remain largely unchanged but the repeater's relative position to the donor gNBs may have changed significantly.

An NCR 130 has the capability to acquire time and frequency synchronization over the air with a donor gNB by detecting and tracking the strongest SSB signal. It can perform signal quality measurement (e.g., RSRP and RSRQ) on the SSB signal as well.

It is proposed to solve these inter-cell mobility related capacity bottlenecks, by extending the NCR concept and framework. In particular, it is proposed that the repeater may assist in the handover of a plurality of active UEs served by the repeater 130. More specifically, the method may comprise the following. This is an overview of possible actions, and more detail is presented below.

A) Instead of each UE performing measurements, the NCR 130 measures time difference (denoted as delta-T) and (optionally but preferably) power difference of the source and target gNB. The measurements or measurement events are signaled/reported to the source gNB.

B) The TDOA/delta-T measured by the NCR is applicable to all UEs as a common change to their individual absolute timing advances (TAs) after the HO.

C) The source gNB 170-1 collects the identity information of the UEs that share a common delta-T, i.e., those served by the repeater, according to certain unique IDs or indices of one or more SSB beams that are used by the repeater towards the UEs.

D) The source gNB triggers an abbreviated HO procedure in the UEs, possibly based on previously-reported UE capabilities regarding the support for abbreviated Hos. The term “abbreviated HO” means that no Msg1 or no Msg1/Msg2 is sent/received by the UEs, as the TA in the target cell is now known before the HO without the need for the target gNB to measure the timing of Msg1/RACH preamble reception.

E) The source gNB signals, at least, the UE identification information to the target gNB 170-2, and the target gNB 170-2 signals back information on HO/mobility resource allocation.

F) Since no Msg1 is sent, there is no risk for collisions and RACH finishes after Msg2/RAR. Msg2 can be treated as in legacy manner, or optionally, the RAR scheduling bottleneck can be eased by the following.

1) Either the source gNB sends the RAR with the HO trigger, or resources can be pre-scheduled with HO trigger to receive RAR PDSCH/MAC CE from the target gNB after HO.

2) The RAR content may be legacy or modified. For instance, the modified RAR may not include a RAPID as there is no RACH preamble transmission and/or the modified RAR may signal a new relative TA command value to a group of UEs (instead of absolute TA values for each RAPID).

During and after HO, the NCR framework may control the NCR beams in such a way that the HO remains transparent to the UEs from a beam-management perspective. This is part of the legacy NCR framework and outside of the scope of this disclosure.

It should be noted that the biggest gains are expected if the NCR assists in handing over whole groups of UEs at the same time. However, the sub-case of assisting each UE separately still brings gain and might be easier in certain situations.

Additional details on the above procedures and the corresponding signaling will be provided below.

As an overview, the exemplary embodiments provide the following;

1) Use of a repeater to perform HO related measurement (e.g., power and/or timing differences between the source and the target cells) in the backhaul link for the handover decision and for uplink timing advance command in RAR. For instance, the handover of UEs served by the repeater is Msg1-less: The target gNB and the UE have enough information to enable the UE to receive RAR directly with the HO command.

2) Use of measured TDOA by the repeater to determine uplink timing advance for a whole group of UEs served by the repeater. In an example, a group handover is used.

3) There are two optional embodiments of RAR handling as an enhancement to the conventional RAR handling: a) Preconfigure a dedicated slot for RAR to be sent by the target gNB; b) Send the RAR (using new RAR content) via the source gNB to the UE such that UE can send Msg3 to the target gNB. New RAR content may be modified to have a group-based TA. The new RAR content could also be sent via dedicated UE-specific channels, which are also more flexible.

4) There may be new signaling between the repeater, source gNB, target gNB and the UE to support the repeater assisted mobility.

Now that an overview has been provided, further details are provided.

Beside the SSB signal as mentioned above, there are other signals that the NCR may use for HO-related measurement. For instance, the repeater may choose to use other physical channel signals to perform measurement on the difference in power and difference in the time of arrival. One example of such a signal may be the CSI-RS signals from the source gNB and the target gNB, which are commonly used for beam tracking or beam refinement purposes.

Another topic concerns collecting the identities of the UEs served by the repeater. When the source gNB 170-1 makes a HO decision based on the measurement from the repeater, the source gNB may act as a proxy to handover a plurality of UEs that are served by the repeater. The source gNB may identify the UEs that are served by the repeater through a number of ways. For example, consider the following.

1) The source gNB 170-1 may assign dedicated SSB indexes to the repeater 130: SSBs may be sent on separate beams and mapped with SSB index as their identifier. Additionally, RACH occasions may have a unique mapping to each SSB index so that a UE indicates the SSB beam to which the UE prefers to connect on by selecting the RO in which the UE sends its RACH preamble. In further detail, the RO is a time-frequency resource set where a UE is allowed to send a PRACH preamble. The RO is configured by the network via broadcast channels for the cell(s). If a specific set of SSBs are dedicated for use through the NCR 130, then the UE's communication through the NCR 130 would be identified based on the selected RO in which the preamble is sent. L1/L2 mobility in this case could allow for a scenario in which the UE is handed from one repeater-based beam to a non-repeater-based beam or vice versa without a full HO, but in this case the gNB is still aware of the beam identifiers for each of its beams and which beams are transmitted through the NCR 130, so whether the UE is connected on a NCR beam or a non-NCR beam is known at the gNB.

2) Unique cell IDs for communication through repeaters: The NCR forwarding may be transparent to the gNB 170, but the gNB 170 should be aware of the NCRs 130, since repeaters are generally considered to be network nodes under the control of the operator. In this case, using a unique cell ID for SSBs transmitted through the NCR would clearly identify which UEs are using the NCR, since the UEs would perform initial access on those specifically identified cells. In this case, connecting to the cell and disconnecting from the cell would be identified either through HO or cell re-selection.

3) Other Implementations: Whereas 1) and 2) for collecting the identities of the UEs served by the repeater are the most likely implementations, there are other alternatives. It may be that the gNB could identify connectivity through the repeater based on some sort of classification of the received RACH preamble. RF fingerprinting is one area of study in which a receiving device could authenticate the transmitting device by identifying unique features from the transmitted signal. If the NCR 130 has a unique RF fingerprint, it may be possible to identify a RACH preamble as sent by the NCR as compared to a RACH preamble as sent by the UE. Other solutions may involve positioning or propagation latency comparison between UEs that are behind the repeater versus the UEs that are directly served by the gNB.

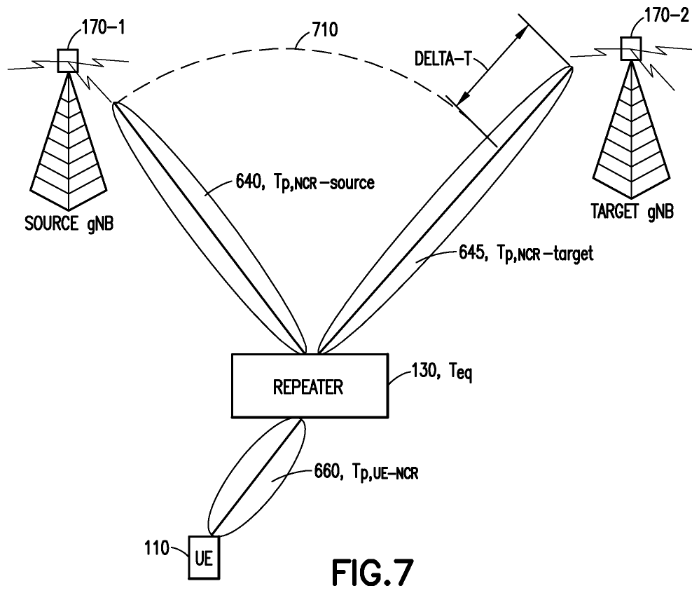

Consider now TDOA measurement by the repeater for timing advance. FIG. 7 is a diagram illustrating delta-T and uplink propagation in an exemplary embodiment. The beams and system (without the train 510) of FIG. 6 are illustrated in FIG. 7. According to FIG. 7, initially the UE 110 is in an active state and is served by source gNB 170-1 through the access beam 660 and the backhaul beam 640 that points at the source gNB. The repeater 130 maintains a timing reference to the source gNB 170-1. The UE's uplink timing advance is maintained by the source gNB 170-1 through the regular timing advance procedure. More specifically, due to the existence of the repeater, the UE timing advance is determined with the objective to compensate the combination of the propagation delay in the access link (T_{(p.UE-NCR)}), the internal delay of the repeater (T_{eq}) and the propagation delay of the backhaul link towards the source gNB (T_{(p.NCR-source)}).

Similarly, in the case when the UE hands over to the target gNB 170-2, the

UE timing advance can be determined with the objective to compensate the combination of the propagation delay in the access link (T(p.UE-NCR)), the internal delay in the repeater (T_{eq}) and the propagation delay of the new backhaul link (backhaul beam 645) towards the target gNB (T_{(p.NCR-target)}).

Since the T(p.UE-NCR) and T_{eq} are common before and after the handover, the change required in uplink timing for the UE can be determined by the difference between the T_{(p.NCR-source)} and T_{(p.NCR-target)} alone.

As the repeater 130 moves towards the target gNB 170-2, the repeater backhaul beam can have SSB signals from the source gNB and target gNB simultaneously, and these can be determined using a receiver (e.g., Rx 162). Since the repeater is already synchronized to the source gNB and using source gNB as a reference, the repeater can measure the difference in time of the arrival of radio signals (i.e., delta-T) between the source SSB and the target SSB, with an accuracy resolution of the sampling period Ts, which is proportional to subcarrier spacing (SCS). In this example, delta-T is shown visually as being measured relative to a line segment 710 that is at a radial location projected to target backhaul beam 645 corresponding to the distance between the repeater and source gNB. In this, delta-T represents the time taken by radio signals to traverse from the target gNB 170-2 to the line segment 710. More mathematically, delta-T may be characterized as the difference in time of arrival of a radio signal between the repeater and a first gNB, and the repeater and a second gNB. If dispersion exists in the radio signals, then the time difference is taken between the strongest paths of the repeater and first gNB, and the repeater and second gNB.

When the target gNB receives the delta-T from the Xn interface from the source gNB, the target gNB can use the delta-T information to calculate the actual timing advance message in the RAR. The value of Timing advance command field in RAR has a coarser resolution than the sampling period rate. For example, in FRI TDD, each timing advance step (one unit of the 12-bit value for the Timing Advance Command) may have a resolution of eight samples, which translate to a distance of 19.5 meters (33.3 μs/per symbol/4096 samples per symbol*3×10⁸ m/s*8). This reaffirms the robustness of this method in that slight movement in the UE in the access link will not change the RAR value.

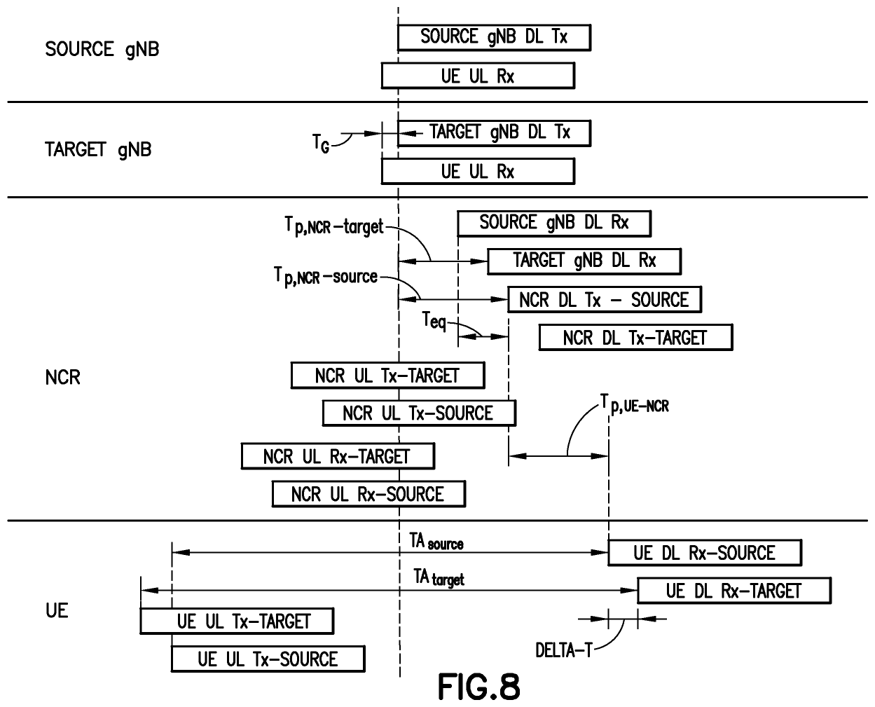

Another point of discussion concerns a DL/UL Timing Diagram for the NCR Assisted Mobility. FIG. 8 illustrates DL and UL Timing for a single repeater, two donor topology, in an exemplary embodiment.

FIG. 8 shows the timing diagram for DL and UL transmissions between the source and target gNBs and the UE via the NCR 130. As indicated, the propagation latency between the NCR and the UE, T_{p,UE-NCR}, is constant regardless of whether the UE is communicating with the source or the target gNB.

As discussed previously, the exemplary embodiments propose to use a signal, delta-T, given as the TDOA of transmissions from both the source gNB and target gNB. This measurement is available at the NCR 130, and can be reported to the source gNB directly and additionally forwarded to the target gNB via the Xn interface. Consider the following equation:

$$delta ‐ T = {T}_{p , source} - {T}_{p , target} ,$$

where,

$$\begin{matrix}{T}_{p , source} = {T}_{p , NCR - source} + {T}_{e q} + {T}_{p , U E - N C R} , and \\ {T}_{p , t a r g e t} = {T}_{p , NCR - t a r g e t} + {T}_{e q} + {T}_{p , U E - N C R} .\end{matrix}$$

Here, T_{eq} is the latency associated with the amplify and forward operation, including any additional signal processing. This latency is a function of NCR capability and independent of which devices are on either end of the repeater link.

For UL transmission alignment, TA=2·Tₚ+T_{G}, where T_{G} is a guard interval to allow for TDD switching and is link independent. Using this determination, TA_{target}=TA_{source}+\dot{2}·delta−T, and delta−T is constant for all UEs being handed over from the source to target via the NCR 130.

Exemplary message flowcharts are now described. These flowcharts illustrate the operation of exemplary methods, results of execution of computer program instructions embodied on a computer readable memory, functions performed by logic implemented in hardware, and/or interconnected means for performing functions in accordance with exemplary embodiments.

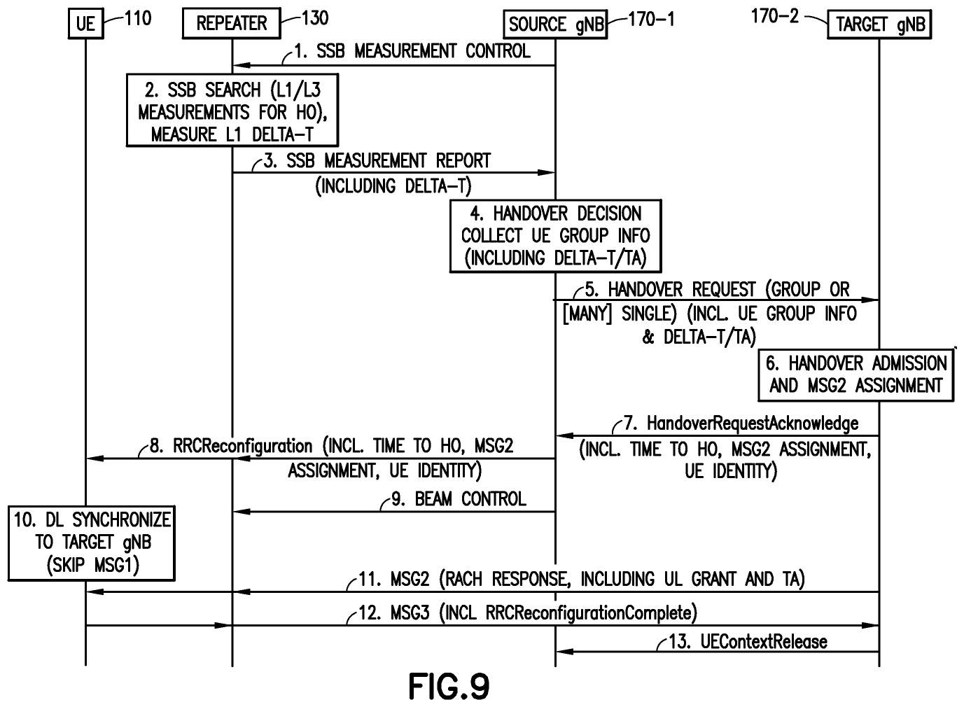

FIG. 9 shows an exemplary flow chart of the repeater-assisted mobility when the Msg1 is bypassed. Initially, the repeater 130 is time/frequency synchronized to the source gNB 170-1 in the backhaul link and the UE 110 is served by the source gNB 170-1 through the repeater 130. Furthermore, the UE is configured to use a common search space for searching for DCI for RRC signaling for a RACH procedure. During the process of periodic SSB sweep, the repeater 130 detects the SSB signals from the target gNB 170-2 and subsequently determines the strongest SSB beam from the target.

In additional detail, RAR content (such as an RAR PDU) is configured to be transmitted in a PDSCH for a RACH procedure and is scheduled using DCI format1_0 (i.e., fallback) transmitted in a Type1-common search space. UEs would have to search this common search space looking for an RA-RNTI to correctly decode the PDSCH and complete the RACH procedure. This process might be less spectrally efficient because the common search space is a shared resource and it can become a bottleneck, but this approach is also more backward compatible since this is the legacy mechanism for completing the RACH procedure.

The steps to perform repeater assisted mobility for this exemplary embodiment comprise the following.

Step 1. The source gNB sends the measurement control message to the repeater. The measurement control message may include handover-related information such as Measurement Objects (e.g., SSB), Reporting Configurations, Measurement Identities (e.g., RSRP), Quantity Configurations (e.g., filtering), and the like. The measurement control message may further include configuration for measuring the time difference between the source gNB and the target gNB. The measurement control message may be a RRC message, or any alternative control layer for controlling the operation of the repeater.

Step 2. The repeater performs the SSB search (L1/L3 measurements for HO) during the SSB burst period and make measurements for handover (e.g., power differences between the source and the target cells, referred to as delta-P) and the time difference of arrival (delta-T) between the source and the target gNB. The measurements may also include serving cell measurements. Further, these measurements can be measurement events for the target cell, such as the A3 event, whereby the target cell is measured as being offset better than the current serving cell.

Step 3. The repeater sends the SSB measurement report to the source gNB. The measurement report may include information such as the repeater ID, the target cell ID and the beam ID of the strongest beam, delta-P and delta-T. The measurement report message may be a RRC message (L3 measurements) or a MAC CE message (L1/L2 measurements).

Step 4. The source gNB makes the handover decision according to the Measurement Report from the repeater. Additionally, the source gNB 170-1 collects the information for the group of the UEs that are served by the repeater, including their identities (e.g., C-RNTI in the source gNB) and their current timing advance (TA) and the delta-T.

Step 5. The source gNB 170-1 sends a group handover request message to the target gNB 170-2. The group handover request message may include information such as the identities of the group of UEs, their time advance (TA) and the delta-T in, e.g., a single message. It is noted that each UE's TA may be different, but delta-T is common. The new TA for the target gNB should be each UE's (current) TA (known to the source gNB)+delta-T. Optionally, many handover request messages may be sent to the target gNB 170-2, with each including information for an individual UE from the group of UEs.

The “delta-T/TA” is based on the following. When performing RACH procedure, a UE is provided a timing advance, TA, which is an offset for when the UE should transmit UL transmissions relative to when it receives DL transmissions. In legacy RACH, each UE would receive this update independently relative to its own DL RX timing. Alternatively, each UE could be provided a timing offset relative to its previous TA (i.e., the TA provided by the source gNB), which is referred to herein as delta-T. Since this delta-T is only a function of propagation delay from the source to the repeater and target to the repeater, delta-T would be the same value for every UE connected to the repeater.

Step 6. The target gNB 170-2 performs admission control and creates the Msg2 assignments for the UEs.

Step 7. The target gNB 170-2 sends a group handover request acknowledge message to the source gNB 170-1. The group handover request acknowledge message may include information such as the group of UEs' identities in the target gNB 170-2, the Msg2 assignment, and the time instant(s) (e.g., slot index) to start the handover. Optionally many handover request acknowledge messages may be sent to the source gNB with each including information for an individual UE from the group of UEs.

Step 8. The source gNB sends the RRCReconfiguration message to the UE individually. The RRCReconfiguration message may include information such as the UE's identity in the target gNB, Msg2 assignment, and the time instant to start the handover.

Step 9. The source gNB 170-1 sends the beam control message to the repeater such that the backhaul beam switching aligns with the cell switching by the UEs. The beam control message may include information such as the repeater ID, and the backhaul beam configuration (e.g., beam direction and time instant to trigger the beam switching).

Step 10. The UE 110 achieves downlink synchronization with the strongest SSB signal from the target gNB and is ready to receive Msg2 based on the Msg2 assignment information from Step 8. That is, Msg 1 is skipped.

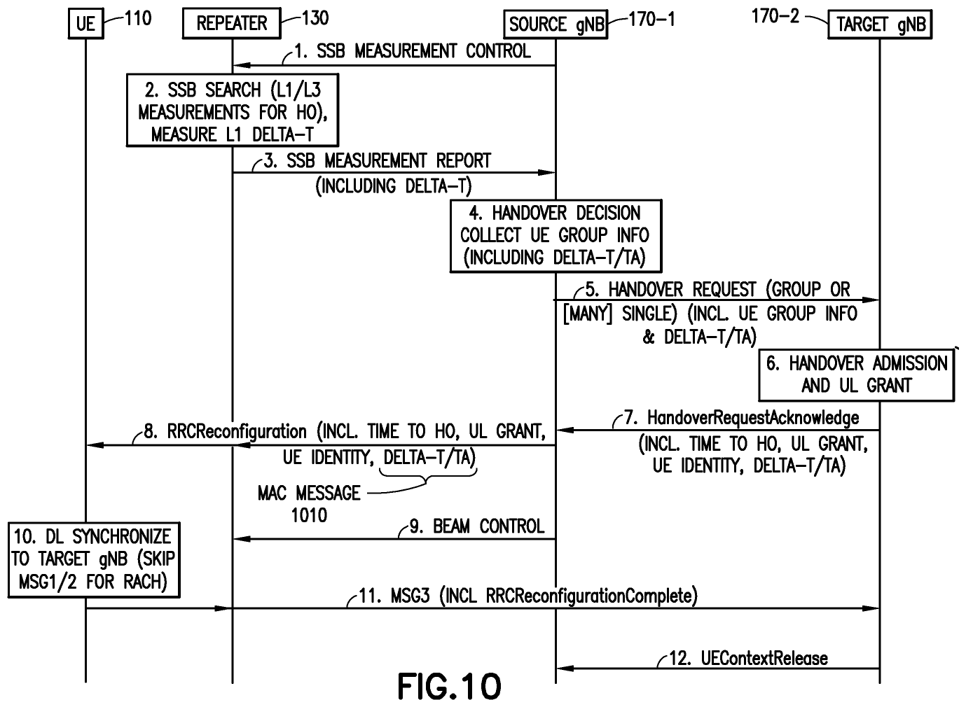

In more technical detail, in step 10, the UE synchronizes to the downlink of the target gNB 170-2 through the strongest SSB. It is not part of the random-access procedure, which starts from the UE's first transmission in the uplink (i.e., Msg1, although this example skips Msg1). The UE is originally synchronized to the downlink of the source base station 170-1, and uplink is also synchronized through the current timing advance (TA). After switching to the target gNB 170-2 (via handover), the downlink and uplink synchronization needs to be re-established. The UE first of all needs to search in the downlink by finding the strongest SSB beam of the target base station and track in time and frequency to the strongest SSB beam (i.e., to synchronize to this beam). Once the downlink synchronization is achieved, the UE 110 can receive Msg2 (which is a downlink signal) from the target base station correctly, and then send Msg3 (uplink) in this embodiment (FIG. 9). In another embodiment (FIG. 10), Msg2 content from the target base station is conveyed to the UE through the source gNB before handover, in this case, the UE can send msg3 after synchronization of the downlink is achieved, and the synchronization technique is the same as between FIGS. 9 and 10.

Msg1 (first message in a random-access process, it is sent by the UE) is used to find the timing advance from the UE to the target base station via the repeater. Since the repeater is mounted on the train, the relative position of the repeater to the UEs are somewhat steady (TA value has a granularity that can tolerate small distances), but the repeater distance to the source/target base stations will change drastically, the latter can be measured by the repeater as delta-T. Once the delta-T and the original TA is known to the target base station, it can inform the UE of the new TA to achieve the uplink synchronization to the target gNB (i.e., in both embodiments of FIGS. 9 and 10, the UE can send Msg3 with the new TA the UE was informed ahead of the handover).

Step 11. The target gNB sends the Msg2 (RAR) to the UE. The RAR may include information such as UL grant for Msg3 and the timing advance (TA) for the target gNB derived from information from Step 5.

Step 12. The UE sends the Msg3 to the target gNB according to the UL grant and the TA from the RAR. The Msg3 may include a RRCReconfigurationComplete message.

Step 13. The target gNB sends a UEContextRelease message to the source gNB to complete the handover.

In another embodiment of repeater assisted mobility, both Msg1 and Msg 2 are bypassed wherein the relevant content of Msg2 is sent by the source gNB 170-1 to the UE 110 prior to the handover, for instance as part of the handover command, as shown in FIG. 10. FIG. 10 has the same starting condition as FIG. 9, where the repeater performs the difference in power and time measurement of the SSB signals and sends the Measurement Report to the source gNB.

However, the important Msg2 information is conveyed to the UEs via the source gNB using a dedicated channel. This can be performed since the source gNB has already configured a dedicated search space for the connected UE and assigned a C-RNTI. This means that the gNB could schedule the PDSCH using DCI format1_1, which is more flexible than the fallback DCI (as used in FIG. 9) and does not need to add congestion to the common search space.

One other consideration is there is a difference between signaling a new TA versus using delta-T, which is a signaling detail. The following describes how this detail might be implemented.

TA: This would be the same value sent in the RAR, but now just in different signaling such as a different PDU. This would be a UE-specific signal that provides the timing offset of UL transmission from the UE relative to the DL Rx timing and may be sent as a dedicated signal from the source TA.

delta-T: This would be a group-specific signal, where the group is all UEs connected to the mobile repeater. Here delta-T is a timing offset for UL transmission to the target gNB relative to the timing offset for UL transmission to the source gNB (old TA assignment). This value would be constant for all UEs connected to the repeater and so could be broadcast in a signal message to all the UEs connected to the repeater. One possible scenario is that the delta-T is sent in a group broadcast, sent only to, e.g., a limited group of UEs that are configured to look for the broadcast.

One benefit of the procedure in FIG. 10 (as compared with FIG. 9) is increase spectral efficiency and flexibility that comes from using dedicated channels to configure the UEs, but this also involves new signaling (e.g., a novel PDU) that the UE would need to be capable of receiving.

The differences between FIG. 10 and FIG. 9 comprise the following.

Step 6. The target gNB performs the Admission Control and create the UL grants for the group of UEs for the future Msg3 transmission.

Step 7. The target gNB 170-2 sends a group handover request acknowledge message to the source gNB 170-1. The handover request acknowledge message may include information such as the group of UEs' identities in the target gNB 170-2, the UL grants for Msg3, and the time instant(s) (e.g., slot index) to start the Handover. Optionally many handover request acknowledge messages may be sent to the source gNB 170-1 with each including information for an individual UE from the group of UEs.

Step 8. The source gNB sends the RRCReconfiguration Message to the UE individually. The RRCReconfiguration Message may include information such as the UE's identity in the target gNB, the UL grant for Msg3, and the time instant to start the handover.

Though this is characterized as everything is in the RRCReconfiguration message, this is only one option. RRCReconfiguration is conventionally an RRC layer message while the RAR is typically a MAC layer message. In the FIG. 10 diagram, the signal flow makes it seem like those two messages have been mixed together. While this is possible (e.g., given a newly defined RRCReconfiguration message), the delta-T/TA information element may be a (e.g., newly defined) MAC layer message sent separately from the RRCReconfiguration, as indicated by reference 1010. Note the MAC layer message is received using the dedicated channel that has already been configured by the source gNB 170-1 for the UE 110.

There is no RAR in FIG. 10, because this method that does not require the RAR. Instead, the relevant for the RAR may be split up and placed in different places in this approach. In general, this information could either be an RRC signal, a MAC signal, or signaled from another layer.

With respect to the MAC layer, a MAC RAR is a collection of MAC subPDUs, where each subPDU contains the necessary information for a specific UE. The contents of a single subPDU are described as follows, wherein the contents are first described, and then notes within brackets ([ . . . ]) pertaining to the contents are provided.

### MAC Subheader:

E: indicates whether this PDU is the last in the sequence [not needed with a dedicated signal, as the PDUs do not have to be aggregated but can be sent independently on each UE's dedicated channel]
T: Indicates whether the RAPID is included [not needed since this technique avoids the use of Msg1 and the proper configure is sent to each UE on a dedicated channel]
R: Reserved bit, set to “0” [can be ignored]
BI: used for resolving PRACH collisions (Msg1) [not needed since Msg1 is not used in this approach]
RAPID: PRACH preamble ID used for sg1 [not needed since msg1 is bypassed]
   subPDU:
Timing advance command (TAC): New TA used to align UL transmissions from UE to target gNB [This may be the only information piece that needs to be sent as part of this new message, alternatively this could be a group-specific signal using delta-T instead of TAC]
UL grant: UL transmission grant for RRC connection re-establishment request [This is not strictly necessary for FIG. 10 if an RRC reconfiguration is used prior to starting the handover process, but in some scenarios, it may be preferrable to simply have the UE initiate the RRC re-establishment without the RRC reconfiguration from the source gNB, so it may make sense to include this]
TC-RNTI: Temporary UE identifier used until the target gNB can establish RRC connection with the UE [Similar to UL grant, this not necessary if an RRC reconfiguration is sent from the source gNB, but may be necessary if the connection is re-established directly between the UE and the target gNB]

Based on this, it is possible to say that the E, T, R, BI, and RAPID fields of the subheader can be removed in the FIG. 10 approach, although this is only one example. UL grant and TC-RNTI could be included optionally for more flexibility, and the TAC or timing-delta are really the main elements that should be transmitted.

Step 10. The UE achieves downlink synchronization with the strongest SSB signal from the target gNB and is ready to send Msg3 based on the Msg3 UL grant information from Step 8. (Msg 1 and Msg2 are skipped.)

A description of capability signaling is now provided. In order to perform repeater assisted mobility, a network-controlled repeater 130 may need to report its capability of supporting differential measurement of physical channel signals to the donor gNB, such that the donor gNB node may set up measurement configurations (e.g., measurement objects, periodicity, threshold, hysteresis, and the like) for the measurement report to be sent by the repeater.

The capability signaling may comprise at least the following parameters:

| - REPEATER_ID | |
|---|---|
| Identification of the repeater | |
| - repeater-measurementSupport-r18 | ENUMERATED {true} |
| - repeater_measurementResources-r18 | |
| ● SSB | ENUMERATED {true} |
| ● CSI-RS | ENUMERATED {true} |
| - repeater_mesaurementCategory-r18 | |
| ● Differential Value | |
| ▪ Difference in signal Power (e.g., RSRP) | ENUMERATED {true} |
| ▪ Difference in signal Quality (e.g., RSRQ) | ENUMERATED {true} |
| ▪ Difference in the time of arrival | ENUMERATED {true} |

In order to implement this, connections to and changes for 3GPP specifications are described.

The NR repeater specification (3GPP TS 38.106) may need to be updated to include a repeater with the capability to support inter cell measurement based on SSB signal and send the measurement report to the source donor.

The repeater assisted handover signal flow as discussed above may be needed to be included in 3GPP TS 38.331.

The modified Random-Access procedure will likely impact 3GPP TS 38.213. L2 based Handover procedure in 3GPP TS 38.321 may be impacted.

The signaling over the Xn interface between the source and target node (3GPP TS 38.422) may be impacted as well.

Benefits and technical effects include the following.

1) Reduced interruption of the user traffic of the UEs serviced by the repeater during handover, which provides better user experience. This is very important for the active users. More specifically,

A) It may be Msg1-less. That is, the repeater provides the uplink timing advance.

i) There may be need for the UEs to send RACH individually. This can avoid network congestion in RACH reception in gNB, and L3 handling in 5G core.

B) This can be made fully contention free.

i) In legacy HO with Msg1, the number of contention free preambles may be limited, and if the contention free preambles are used up, the gNB will use contention-based preamble for HO which may result in collision and latency.

ii) In an exemplary embodiment, the access identities go through messaging, and collision can be avoided (for example, use C-RNTI as in the optional embodiments of the RAR handing).

C) Due to the optional enhancements to RAR reception, there is no need for RAR window, as the RAR timing (e.g., slot offset) is preconfigured in some exemplary embodiments.

D) There may be less measurement overhead, since one entity (repeater) may perform the HO related measurement, which avoids a large amount of measurement reports by individual UEs and measurement gaps.

E) Group based handover may be performed, which provides less signaling overhead and should be faster.

2) Lower messaging overhead.

A) Measurement by the repeater in the backhaul link can be used to replace a large number of measurement reports by a plurality of UEs, if these UEs were to perform HO measurement reporting individually.

B) The existing per-UE messaging may be expanded to include a group of UEs (e.g., UE context setup may be expanded to include a plurality of UEs) to save messaging overhead.

3) Power saving.

A) For the UE side:

i) Msg1-less: the UE does not need to send Msg1, which saves power.

ii) No need for RAR window. The UE does not need to blind search for the PDCCH with RA-RNTI in all DL slots within RAR window. There are proposed two enhancements for RAR handling: a) The UE knows which slot contains the RAR ahead of time b) The content of RAR is sent by the source gNB. Both of which do not require RAR window.

iii) The UE can be preconfigured to receive the SSB for downlink synchronization at a specific time instant (e.g., symbol offset) of the intended (i.e., the strongest) SSB. The UE saves the power by not having to perform a blind SSB sweep and search in order to synchronize to the strongest SSB. Optionally the UE can be pre-informed of the target cell id and beam id, to facilitate the synchronization, resulting in less processing.

B) For the gNB side:

i) There is no need for a large amount of RACH preamble processing and

individual UL timing advance calculation by individual UEs.

ii) There is no need for the processing power to handle a large amount of measurement reports from individual UEs.

4) Besides Msg1-less, exemplary embodiments may still use the same framework of Msg3, Msg4, and possibly of Msg2. for the rest of the RACH procedure.

i) This is easier to be accepted when it comes to repeater handover, as there are not drastic changes from conventional techniques.

ii) It is fully compatible with some other HO related optimizations (e.g., 2 step/4 step Rach, L1-L2 mobility, grouped handover at higher layer, and the like).

Additional examples are as follows.

Example 1. A repeater, comprising means for performing:
relaying communications between a plurality of user equipment and a first base station;
measuring a time difference between signals received from the first base station and signals received from a second base station;
performing cell measurements of signals received from the first base station and of signals received from the second base station; and
sending, to the first base station, information indicative of the measured time difference and of the cell measurements.

Example 2. The repeater according to example 1, wherein the communications between the plurality of user equipment and the first base station are relayed in the radio frequency domain,
and wherein the means are further configured to perform a synchronization signal block search during a burst period for measuring the time difference and for performing the cell measurements.

Example 3. The repeater according to example 1 or 2, wherein the information indicative of the measured time difference and of the cell measurements are sent to the first base station for handover of the plurality of user equipment from a first cell operated by the first base station to a second cell operated by the second base station, and wherein the signals received from the first base station are associated with the first cell, and the signals received from the second base station are associated with the second cell.

Example 4. The repeater according to any one of examples 1 to 3, wherein:
performing the cell measurements comprise measuring a first power of signals received from the first bast station and a second power of signals received from the second bast station; or
measuring the time difference comprises measuring a time difference of arrival between signals received from the first bast station and signals received from the second base station;

Example 5. The repeater according to any one of examples 1 to 4, wherein the information indicative of the cell measurements comprise a measurement event fulfilled by the cell measurements.

Example 6. The repeater according to any one of examples 1 to 5, wherein the means are further configured to perform:
receiving, from the first base station, a Msg2 assignment for an individual one of the plurality of user equipment to use in a random-access procedure of the individual user equipment with the second base station that skips Msg1; and
relaying, to the individual user equipment, the Msg2 assignment.

Example 7. The repeater according to any one of examples 1 to 5, wherein the means are further configured to perform:
receiving, from the first base station, an uplink grant for an individual one of the plurality of user equipment to use in a random-access procedure of the individual user equipment with the second base station that skips Msg1 and Msg2; and relaying, to the individual user equipment, the uplink grant.

Example 8. The repeater according to example 7, wherein:
the receiving the uplink grant further comprises receiving either a timing advance to be used by the individual user equipment for uplink communication with the second base station or the time difference; and
the relaying the uplink grant further comprises relaying, to the user equipment, the received timing advance or the received time difference.

Example 9. An apparatus comprising the repeater of any one of examples 1 to 8.

Example 10. A first base station, comprising means for performing:
communicating with a plurality of user equipment though a repeater,
receiving, from the repeater, information indicative of a time difference between signals received from the first base station and signals received from a second base station as measured by the repeater, and of cell measurements by the repeater of signals received from the first base station and of signals received from the second base station; and
making a handover decision for the plurality of user equipment based at least on the received information indicative of the cell measurements.

Example 11. The first base station according to example 10, wherein, in response to a handover decision for the plurality of user equipment from the first base station to the second base station, made by the first base station based at least on the received information indicative of the cell measurements, sending one or more handover request messages to the second base station, the one or more handover request messages comprising information to identify the plurality of user equipment and to enable the second base station to determine timing advances to be used by the plurality of user equipment for uplink communication with the second base station.

Example 12. The first base station according to example 11, wherein the information to enable the second base station to determine timing advances to be used by the plurality of user equipment for uplink communication with the second base station comprises:
the time difference between signals received from the first base station and signals received from the second base station as measured by the repeater; and
timing advances used by the plurality of user equipment for uplink communication with the first base station.

Example 13. The first base station according to example 12, wherein the following are sent in a single handover request message: the information identifying the plurality of user equipment; the time difference between signals received from the first base station and signals received from the second base station as measured by the repeater; and the timing advances used by the plurality of user equipment for uplink communication with the first base station.

Example 14. The first base station according to example 12, wherein the one or more handover request messages comprise individual handover request messages corresponding to individual ones of the plurality of user equipment, and wherein the individual handover request messages comprise:
information to identify an individual one of the plurality of user equipment;
the time difference between signals received from the first base station and signals received from the second base station as measured by the repeater, and a timing advance used by the individual user equipment for uplink communication with the first base station.

Example 15. The first base station according to example 11, wherein:
the means are further configured to perform determining individual timing advances for the plurality of the user equipment based on timing advances used by the plurality of user equipment for uplink communication with the first base station and on the time difference between signals received from the first base station and signals received from the second base station as measured by the repeater;
the one or more handover request messages comprise individual handover request messages corresponding to individual ones of the plurality of user equipment, and wherein the individual handover request messages comprise:
information to identify the individual user equipment;
the information that enables the second base station to determine a timing advance for the plurality of user equipment comprises the determined individual timing advance corresponding to the individual user equipment.

Example 16. The first base station according to any one of examples 11 to 15, wherein the means are further configured to perform:
receiving an indication that a handover of an individual one of the plurality of user equipment from the first base station to the second base station is acknowledged by the second base station, the indication comprising a Msg2 assignment for the individual user equipment to use in a random-access procedure of the individual user equipment with the second base station that skips Msg1; and
sending a message comprising the Msg2 assignment to the individual user equipment.

Example 17. The first base station according to example 14, wherein the means are further configured to perform:
sending, to the individual user equipment, the time difference between signals received from the first base station and signals received from the second base station as measured by the repeater,
wherein the sending of the time difference is sent in a message to the individual user equipment comprising an uplink assignment, or is broadcast from the first base station and intended for a group of user equipment of which the individual user equipment is one group member.

Example 18. The first base station according to example 15, wherein the means are further configured to perform:
sending, to the individual user equipment, a timing advance to use by the individual user equipment for uplink communication with the second base station, wherein the timing advance is sent in a medium access control message using a search space dedicated for the individual user equipment.

Example 19. The first base station according to any one of examples 17 or 18, wherein the means are further configured to perform:
receiving an indication that a handover of an individual one of the plurality of user equipment from the first base station to the second base station is acknowledged by the second base station, the indication comprising an uplink grant for the individual user equipment to use in a random-access procedure of the individual user equipment with the second base station that skips Msg1 and Msg2; and
sending a message comprising the uplink grant to the individual user equipment.

Example 20. An apparatus comprising the first base station of any one of examples 10 to 19.

Example 21. The repeater according to any one of examples 1 to 8 or the first base station according to any one of examples 10 to 19, wherein the means comprises:
at least one processor; and
at least one memory including computer program code, the at least one memory and computer program code configured to, with the at least one processor, cause the performance of the apparatus.

Example 22. A method, comprising:
relaying, by a repeater, communications between a plurality of user equipment and a first base station;
measuring, by the repeater, a time difference between signals received from the first base station and signals received from a second base station;
performing, by the repeater, cell measurements of signals received from the first base station and of signals received from the second base station; and
sending, by the repeater to the first base station, information indicative of the measured time difference and of the cell measurements.

Example 23. The method according to example 22, wherein the communications between the plurality of user equipment and the first base station are relayed in the radio frequency domain, and wherein the method further comprises performing a synchronization signal block search during a burst period for measuring the time difference and for performing the cell measurements.

Example 24. The method according to example 22 or 23, wherein the information indicative of the measured time difference and of the cell measurements are sent to the first base station for handover of the plurality of user equipment from a first cell operated by the first base station to a second cell operated by the second base station, and wherein the signals received from the first base station are associated with the first cell, and the signals received from the second base station are associated with the second cell.

Example 25. The method according to any one of examples 22 to 24, wherein:
performing the cell measurements comprise measuring a first power of signals received from the first bast station and a second power of signals received from the second bast station; or
measuring the time difference comprises measuring a time difference of arrival between signals received from the first bast station and signals received from the second base station;

Example 26. The method according to any one of examples 22 to 25, wherein the information indicative of the cell measurements comprise a measurement event fulfilled by the cell measurements.

Example 27. The method according to any one of examples 22 to 26, wherein the method further comprises:
receiving, from the first base station, a Msg2 assignment for an individual one of the plurality of user equipment to use in a random-access procedure of the individual user equipment with the second base station that skips Msg1; and
relaying, to the individual user equipment, the Msg2 assignment.

Example 28. The method according to any one of examples 22 to 26, wherein the method further comprises:
receiving, from the first base station, an uplink grant for an individual one of the plurality of user equipment to use in a random-access procedure of the individual user equipment with the second base station that skips Msg1 and Msg2; and
relaying, to the individual user equipment, the uplink grant.

Example 29. The method according to example 28, wherein:
the receiving the uplink grant further comprises receiving either a timing advance to be used by the individual user equipment for uplink communication with the second base station or the time difference; and
the relaying the uplink grant further comprises relaying, to the user

equipment, the received timing advance or the received time difference.

Example 30. A method, comprising:
communicating, by a first base station, with a plurality of user equipment though a repeater,
receiving, from the repeater, information indicative of a time difference between signals received from the first base station and signals received from a second base station as measured by the repeater, and of cell measurements by the repeater of signals received from the first base station and of signals received from the second base station; and
making a handover decision for the plurality of user equipment based at least on the received information indicative of the cell measurements.

Example 31. The method according to example 30, wherein, in response to a handover decision for the plurality of user equipment from the first base station to the second base station, made by the first base station based at least on the received information indicative of the cell measurements, sending one or more handover request messages to the second base station, the one or more handover request messages comprising information to identify the plurality of user equipment and to enable the second base station to determine timing advances to be used by the plurality of user equipment for uplink communication with the second base station.

Example 32. The method according to example 31, wherein the information to enable the second base station to determine timing advances to be used by the plurality of user equipment for uplink communication with the second base station comprises:
the time difference between signals received from the first base station and signals received from the second base station as measured by the repeater; and
timing advances used by the plurality of user equipment for uplink communication with the first base station.

Example 33. The method according to example 32, wherein the following are sent in a single handover request message: the information identifying the plurality of user equipment; the time difference between signals received from the first base station and signals received from the second base station as measured by the repeater; and the timing advances used by the plurality of user equipment for uplink communication with the first base station.

Example 34. The method according to example 32, wherein the one or more handover request messages comprise individual handover request messages corresponding to individual ones of the plurality of user equipment, and wherein the individual handover request messages comprise:
information to identify an individual one of the plurality of user equipment;
the time difference between signals received from the first base station and signals received from the second base station as measured by the repeater, and a timing advance used by the individual user equipment for uplink communication with the first base station.

Example 35. The method according to example 32, wherein:
the method further comprises determining individual timing advances for the plurality of the user equipment based on timing advances used by the plurality of user equipment for uplink communication with the first base station and on the time difference between signals received from the first base station and signals received from the second base station as measured by the repeater;
the one or more handover request messages comprise individual handover request messages corresponding to individual ones of the plurality of user equipment, and wherein the individual handover request messages comprise:
information to identify the individual user equipment;
the information that enables the second base station to determine a timing advance for the plurality of user equipment comprises the determined individual timing advance corresponding to the individual user equipment.

Example 36. The method according to any one of examples 32 to 35, wherein the method further comprises:
receiving an indication that a handover of an individual one of the plurality of user equipment from the first base station to the second base station is acknowledged by the second base station, the indication comprising a Msg2 assignment for the individual user equipment to use in a random-access procedure of the individual user equipment with the second base station that skips Msg1; and
sending a message comprising the Msg2 assignment to the individual user equipment.

Example 37. The method according to example 34, wherein the method further comprises:
sending, to the individual user equipment, the time difference between signals received from the first base station and signals received from the second base station as measured by the repeater,
wherein the sending of the time difference is sent in a message to the individual user equipment comprising an uplink assignment, or is broadcast from the first base station and intended for a group of user equipment of which the individual user equipment is one group member.

Example 38. The method according to example 35, wherein the method further comprises:
sending, to the individual user equipment, a timing advance to use by the individual user equipment for uplink communication with the second base station, wherein the timing advance is sent in a medium access control message using a search space dedicated for the individual user equipment.

Example 39. The method according to any one of examples 37 or 38, wherein the method further comprises:
receiving an indication that a handover of an individual one of the plurality of user equipment from the first base station to the second base station is acknowledged by the second base station, the indication comprising an uplink grant for the individual user equipment to use in a random-access procedure of the individual user equipment with the second base station that skips Msg1 and Msg2; and
sending a message comprising the uplink grant to the individual user equipment.

Example 40. A computer program, comprising code for performing the methods of any of examples 22 to 39, when the computer program is run on a computer.

Example 41. The computer program according to example 40, wherein the computer program is a computer program product comprising a computer-readable medium bearing computer program code embodied therein for use with the computer.

Example 42. The computer program according to example 40, wherein the computer program is directly loadable into an internal memory of the computer.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 155 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

| | |
|---|---|
| 3GPP | third generation partnership project |
| 5G | fifth generation |
| 5GC | 5G core network |
| ADC | analog-to-digital conversion or converter |
| AMF | access and mobility management function |
| BS | base station |
| CE | control element |
| C-RNTI | cell-radio network temporary identifier |
| CSI-RS | channel state information - reference signal |
| CU | central unit |
| DAC | digital-to-analog conversion or converter |
| DAPS | dual active protocol stack |
| DCI | downlink control information |
| DL | downlink |
| DU | distributed unit |
| eNB (or eNodeB) | evolved Node B (e.g., an LTE base station) |
| EN-DC | E-UTRA-NR dual connectivity |
| en-gNB or En-gNB | node providing NR user plane and control plane |
| | protocol terminations towards the UE, and acting as |
| | secondary node in EN-DC |
| E-UTRA | evolved universal terrestrial radio access, i.e., the |
| | LTE radio access technology |
| gNB (or gNodeB) | base station for 5G/NR, i.e., a node providing NR |
| | user plane and control plane protocol terminations |
| | towards the UE, and connected via the NG interface |
| | to the 5GC |
| HO | handover |
| IAB | Integrated Access and Backhaul |
| Id or ID | identification |
| I/F | interface |
| LTE | long term evolution |
| MAC | medium access control |
| MME | mobility management entity |
| MO | measurement object |
| MT | mobile terminal |
| NCR | network-controlled repeaters |
| ng or NG | next generation |
| ng-eNB or NG-eNB | next generation eNB |
| NR | new radio |
| N/W or NW | network |
| PCI | physical cell identifier |
| PDCCH | physical downlink control channel |
| PDCH | physical downlink channel |
| PDCP | packet data convergence protocol |
| PDSCH | physical downlink shared channel |
| PDU | protocol data unit |
| PHY | physical layer |
| RACH | random access channel |
| RAN | radio access network |
| RAPID | random access preamble ID |
| RAR | random access response |
| Rel | release |
| RF | radio frequency |
| RLC | radio link control |
| RNTI | radio network temporary identifier |
| RO | RACH occasion |
| RSRP | reference signal received power |
| RSRQ | reference signal received quality |
| RRH | remote radio head |
| RRC | radio resource control |
| RU | radio unit |
| Rx | receiver |
| SCS | subcarrier spacing |
| SDAP | service data adaptation protocol |
| SGW | serving gateway |
| SMF | session management function |
| SNR | signal to noise ratio |
| SSB | synchronization signal block |
| SR | smart repeater |
| TA | timing advance |
| TAC | timing advance command |
| TC-RNTI | temporary cell-RNTI |
| TDD | time division duplexing |
| TDOA | time difference of arrival |
| TS | technical specification |
| Tx | transmitter |
| UE | user equipment (e.g., a wireless, typically mobile |
| | device) |
| UL | uplink |
| UPF | user plane function |
| WI | work item |

1. A repeater comprising:
at least one processor; and,
at least one memory storing instructions that, when executed by the at least one processor, cause the repeater to perform:
relaying communications between a plurality of user equipment and a first base station;
measuring a time difference between signals received from the first base station and signals received from a second base station;
performing cell measurements of signals received from the first base station and of signals received from the second base station; and
sending, to the first base station, information indicative of the measured time difference and of the cell measurements.

2. The repeater according to claim 1, wherein the information indicative of the measured time difference and of the cell measurements are sent to the first base station for handover of the plurality of user equipment from a first cell operated by the first base station to a second cell operated by the second base station, and wherein the signals received from the first base station are associated with the first cell, and the signals received from the second base station are associated with the second cell.

3. The repeater according to claim 1, wherein:
performing the cell measurements comprise measuring a first power of signals received from the first bast station and a second power of signals received from the second bast station; or
measuring the time difference comprises measuring a time difference of arrival between signals received from the first bast station and signals received from the second base station;

4. The repeater according to claim 1, wherein the information indicative of the cell measurements comprise a measurement event fulfilled by the cell measurements.

5. The repeater according to claim 1, wherein the repeater is further caused to perform:
receiving, from the first base station, a Msg2 assignment for an individual one of the plurality of user equipment to use in a random-access procedure of the individual user equipment with the second base station that skips Msg1; and
relaying, to the individual user equipment, the Msg2 assignment.

6. The repeater according to claim 1, wherein the repeater is further caused to perform:
receiving, from the first base station, an uplink grant for an individual one of the plurality of user equipment to use in a random-access procedure of the individual user equipment with the second base station that skips Msg1 and Msg2; and
relaying, to the individual user equipment, the uplink grant.

7. The repeater according to claim 6, wherein:
the receiving the uplink grant further comprises receiving either a timing advance to be used by the individual user equipment for uplink communication with the second base station or the time difference; and
the relaying the uplink grant further comprises relaying, to the user equipment, the received timing advance or the received time difference.

8. The repeater according to claim 1, wherein the communications between the plurality of user equipment and the first base station are relayed in the radio frequency domain,
and wherein the repeater is further caused to perform a synchronization signal block search during a burst period for measuring the time difference and for performing the cell measurements.

9. An apparatus comprising the repeater of claim 1.

10. A first base station, comprising:
at least one processor; and,
at least one memory storing instructions that, when executed by the at least one processor, cause the first base station to perform:
communicating with a plurality of user equipment though a repeater,
receiving, from the repeater, information indicative of a time difference between signals received from the first base station and signals received from a second base station as measured by the repeater, and of cell measurements by the repeater of signals received from the first base station and of signals received from the second base station; and
making a handover decision for the plurality of user equipment based at least on the received information indicative of the cell measurements.

11. The first base station according to claim 10, wherein, in response to a handover decision for the plurality of user equipment from the first base station to the second base station, made by the first base station based at least on the received information indicative of the cell measurements, sending one or more handover request messages to the second base station, the one or more handover request messages comprising information to identify the plurality of user equipment and to enable the second base station to determine timing advances to be used by the plurality of user equipment for uplink communication with the second base station.

12. The first base station according to claim 11, wherein the information to enable the second base station to determine timing advances to be used by the plurality of user equipment for uplink communication with the second base station comprises:
the time difference between signals received from the first base station and signals received from the second base station as measured by the repeater; and
timing advances used by the plurality of user equipment for uplink communication with the first base station.

13. The first base station according to claim 12, wherein the following are sent in a single handover request message: the information identifying the plurality of user equipment; the time difference between signals received from the first base station and signals received from the second base station as measured by the repeater; and the timing advances used by the plurality of user equipment for uplink communication with the first base station.

14. The first base station according to claim 12, wherein the one or more handover request messages comprise individual handover request messages corresponding to individual ones of the plurality of user equipment, and wherein the individual handover request messages comprise:
information to identify an individual one of the plurality of user equipment;
the time difference between signals received from the first base station and signals received from the second base station as measured by the repeater, and a timing advance used by the individual user equipment for uplink communication with the first base station.

15. The first base station according to claim 11, wherein:
the first base station is further caused to perform determining individual timing advances for the plurality of the user equipment based on timing advances used by the plurality of user equipment for uplink communication with the first base station and on the time difference between signals received from the first base station and signals received from the second base station as measured by the repeater;
the one or more handover request messages comprise individual handover request messages corresponding to individual ones of the plurality of user equipment, and wherein the individual handover request messages comprise:
information to identify the individual user equipment;
the information that enables the second base station to determine a timing advance for the plurality of user equipment comprises the determined individual timing advance corresponding to the individual user equipment.

16. The first base station according to claim 14, wherein the first base station is further caused to perform:
sending, to the individual user equipment, the time difference between signals received from the first base station and signals received from the second base station as measured by the repeater,
wherein the sending of the time difference is sent in a message to the individual user equipment comprising an uplink assignment, or is broadcast from the first base station and intended for a group of user equipment of which the individual user equipment is one group member.

17. The first base station according to claim 15, wherein the first base station is further caused to perform:
sending, to the individual user equipment, a timing advance to use by the individual user equipment for uplink communication with the second base station, wherein the timing advance is sent in a medium access control message using a search space dedicated for the individual user equipment.

18. The first base station according to claim 16, wherein the first base station is further caused to perform:
receiving an indication that a handover of an individual one of the plurality of user equipment from the first base station to the second base station is acknowledged by the second base station, the indication comprising an uplink grant for the individual user equipment to use in a random-access procedure of the individual user equipment with the second base station that skips Msg1 and Msg2; and
sending a message comprising the uplink grant to the individual user equipment.

19. An apparatus comprising the first base station of claim 10.

20. (canceled)

21. A method, comprising:
relaying, by a repeater, communications between a plurality of user equipment and a first base station;
measuring, by the repeater, a time difference between signals received from the first base station and signals received from a second base station;
performing, by the repeater, cell measurements of signals received from the first base station and of signals received from the second base station; and
sending, by the repeater to the first base station, information indicative of the measured time difference and of the cell measurements.

22. (canceled)
